(19) United States
(12) Patent Application Publication
(10) Pub. No.: US 2009/0122331 A1
(43) Pub. Date: May 14, 2009

(54) Facsimile machine

(75) Inventor: Yoshiaki Yasui, Osaka (JP)

Correspondence Address: JORDAN AND HAMBURG LLP, 122 EAST 42ND STREET, SUITE 4000, NEW YORK, NY, 10168, US

(73) Assignee: KYOCERA MITA CORPORATION, Chuo-ku (JP)

(21) Appl. No.: 12/288,265

(22) Filed: Oct. 17, 2008

(30) Foreign Application Priority Data
Oct. 17, 2007 (JP) 2007-270257
Oct. 17, 2007 (JP) 2007-270258

(51) Int. Cl. G06K 15/00

(52) U.S. Cl. 358/1.14

(57) ABSTRACT

A communication rate management section reads out a communication rate at the time of occurrence of a communication error related to a destination machine having been selected by a user, based on stored information in a communication history table, when starting image data communication with the destination machine, the communication rate management section also calculating a communication rate with the destination machine in consideration of having a decrease by at least one level or more from the read-out communication rate, and having a facsimile communication section execute communication processing with the destination machine at the calculated communication rate. As a result, the frequency of occurrence of communication errors can be suppressed as much as possible.

### BACKGROUND OF THE INVENTION

1. Field of the Invention

The present invention relates to a facsimile machine provided with a facsimile communication section executing image data communication processing via a communication medium between the facsimile machine and a destination machine at a communication rate selected according to predetermined rules among a plurality of communication rates set in a stepwise manner, and in particular, to a facsimile machine capable of suppressing the frequency of occurrence of communication errors as much as possible even when the communication medium is in a poor condition.

2. Description of the Related Art

A conventional facsimile machine is generally configured to selectively set by automatic or manual operation an appropriate communication rate based on a communication ability of the facsimile machine and a communication ability of a desired destination receiver (herein after, referred to as a ‘destination machine’) from a plurality of communication rates in a stepwise manner, when transmitting predetermined image data to the destination machine.

Herein, as a factor to be considered in setting a communication rate between the facsimile machine and the destination machine, a condition of the communication medium such as a public line network, etc., can be cited. For example, when the condition of the communication medium is in a poor condition due to disturbance such as electromagnetic noise, it becomes necessary to perform appropriate communication rate control for reducing the communication rate, etc., in order to avoid communication errors as much as possible.

As one of the approaches to such communication rate control, an art of fallback control has been known in which when a communication error occurs at a certain communication rate, re-communication is repeated multiple times with the communication rate maintained, and after the number of times of the re-communication reaches a predetermined number of times, the communication rate is reset at a lower rate side through a process of transmitting and receiving various signals pursuant to a predetermined communications protocol.

Further, the present inventors propose a facsimile machine, with the aim of performing communication at a higher communication rate while suppressing frequent occurrence of fallback control, including a communication history table in which a communication rate at the time of transmission and reception of image data is stored for each destination receiver, a maximum communication rate acquisition section acquiring maximum communication rate information of a selected receiver from a DIS signal having been sent from the selected receiver before starting image data transmission to the receiver, a deducing section deducing a lower maximum communication rate from a possible maximum communication rate of the receiver and a maximum communication rate of the facsimile machine, and a communication rate determination section setting a communication rate initial value at the start of this forthcoming communication to a rate higher than a communication rate at the time of the previous transmission and reception with a receiver to be communicated this time having been read out from a storage section, in a range without exceeding the possible maximum communication rate of the receiver, according to the lower maximum communication rate having been deduced by the deducing section and the communication rate at the time of the previous transmission and reception with the receiver (see Japanese Published Unexamined Patent Application No. 2001-313807, for example).

In the aforementioned prior art, however, the forthcoming communication rate is uniformly set at a higher rate than this communication rate at the time of the previous transmission and reception irrespective of whether its communication result is good or bad. Therefore, there is a possibility of inviting frequent occurrence of communication errors, for example, when the communication medium is in a poor condition.

### SUMMARY OF THE INVENTION

Accordingly, it is an object of the present invention to provide a facsimile machine capable of suppressing the frequency of occurrence of communication errors as much as possible even when a communication medium is in a poor condition.

In order to achieve the aforementioned object, it is the most principal characteristic to be constructed so that a facsimile machine according to the present invention includes a facsimile communication section executing image data communication processing via a communication medium between the facsimile machine and a destination machine at a communication rate selected according to predetermined rules among a plurality of communication rates set in a stepwise manner, a communication result determination section determining whether a communication error occurs during image data communication with a destination machine, a communication history table in which when a determination that a communication error occurs is made in the communication result determination section, a communication rate at the time of occurrence of the communication error is stored as associated with the relevant destination machine, a communication rate management section reading out a communication rate at the time of occurrence of a communication error related to a destination machine having been selected by a user, based on stored information in the communication history table, when starting image data communication with the destination machine, the communication rate management section also calculating a communication rate with the destination machine in consideration of having a decrease by at least one level or more from the read-out communication rate, and having the facsimile communication section execute the communication processing with the destination machine at the calculated communication rate.

### ACTIONS AND EFFECTS OF THE INVENTION

In the facsimile machine according to the present invention, the communication result determination section determines whether a communication error occurs during image data communication with a destination machine. When a determination that a communication error occurs is made in the communication result determination section, a communication rate at the time of occurrence of the communication error is stored in the communication history table as associated with the relevant destination machine. When starting image data communication with a destination machine having been selected by a user, the communication rate management section reads out a communication rate at the time of occurrence of a communication error related to the destination machine, based on stored information in the communication history table. The communication rate management section also calculates a communication rate with the destination machine in consideration of having a decrease by at least one level or more from the read-out communication rate and has the facsimile communication section execute communication processing with the destination machine at the calculated communication rate. Consequently, with reference to the communication rate at the time of occurrence of the past communication error with the destination machine, the communication processing with the destination machine is executed at a communication rate with a decrease by at least one level or more from the reference communication rate. Thus, the communication processing with the destination machine is executed at a relatively low communication rate that is assumed to be able to obviate occurrence of communication errors. As a result, the frequency of occurrence of communication errors can be suppressed as much as possible even when the communication medium is in a poor condition.

### BRIEF DESCRIPTION OF THE DRAWINGS

FIG. 1 is a block diagram showing a general configuration of a facsimile machine according to an embodiment of the present invention;

FIG. 2 is an external view of an operation panel section of the facsimile machine according to the embodiment of the present invention;

FIG. 3 is an operational flowchart of the facsimile machine according to the embodiment of the present invention;

FIG. 4 an explanatory diagram showing a configuration example of a communication history table;

FIG. 5 is an operational flowchart of the facsimile machine when a determination that a communication error does not occur is made;

FIG. 6 is a diagram showing a facsimile communication procedure when the facsimile machine transmits image data to a destination machine;

FIG. 7 is a diagram showing a facsimile communication procedure when the facsimile machine receives image data transmitted by the destination machine; and

FIG. 8 is an explanatory diagram in having an operation of combining one or two or more of the following performed; printing out, displaying to a display section, taking out as external output data, updating, and deleting storage information in a communication history table 79 in accordance with user operation instructions.

### DETAILED DESCRIPTION OF THE PREFERRED EMBODIMENTS

Hereinafter, a facsimile machine according to an embodiment of the present invention is described in detail with reference to the drawings.

As the facsimile machine according to the embodiment of the present invention, exemplified and described below is a digital multifunction device provided with various functions for image formation such as a copy function, a printer function, a scanner function other than a facsimile communication function. Further, the description below is given on the assumption that a fundamental configuration of the facsimile machine according to the embodiment of the present invention is common between the facsimile machine and a destination machine.

### [General Configuration of a Facsimile Machine (Digital Multifunction Device) According to an Embodiment of the Present Invention]

A facsimile machine 10 according to an embodiment of the present invention has a communication processing function of executing image data communication processing between the facsimile machine and a destination machine via a communication medium at a communication rate selected in accordance with predetermined rules among a plurality of communication rates set in a stepwise manner (for example, 2400, 4800, 7200, 9600, 12000, 14400, 16800, 19200, 21600, 26400, and 28800 where the unit is bps). That is, various functions including a copy job, a print job, or a network transmission (mail transmission or data transmission) job other than a facsimile communication job are available in the facsimile machine 10, which is controlled by a main control section 11 composed of a microcomputer and dedicated hardware circuitry, etc. As input/output devices connected to the main control section 11 and taking charge of various functions, the machine 10 includes a scanner section 21, an image processing section 31, an engine section 41, an operation panel section 51, a hard disk drive (HDD) 61, a network interface (I/F) section 63, and a facsimile communication section 65.

The main control section 11 houses a scanner controller 13 controlling an operation for realizing a scanner function, a copy controller 15 controlling an operation for realizing a copy function, a printer controller 17 controlling an operation for realizing a printer function, and a facsimile controller 19 controlling an operation for realizing a facsimile function. The main control section 11 has overall control for an operation of the entire apparatus.

The scanner section 21 includes an image irradiation lamp 23 and a charge coupled device (CCD) sensor 25 constituting a scanner (not shown). The image irradiation lamp 23 irradiates a document and the CCD sensor 25 receives its reflected light, whereby the scanner section 21 reads out an image from the document and outputs image data corresponding to the read-out image to the image processing section 31.

The image processing section 31 includes a correction section 33, an image manipulation section 35, and an image memory 37. The image processing section 31 processes the image data having been read by the scanner section 21, with use of the correction section 33 and the image manipulation section 35 as necessary, and stores the processed image data on the image memory 37 or outputs the processed image data to the engine section 41 and the facsimile communication section 65 etc. The correction section 33 makes a predetermined correction processing such as level correction, gamma correction, and the like to the image data which has been read by the scanner section 21. The image manipulation section 35 executes various manipulating processing such as compression or expansion and scaling of image data.

The engine section 41 includes a paper conveying section 43 composed of a paper feeding cassette, a paper feeding roller, etc., which are not shown, an image forming section 45 composed of a photosensitive drum, an exposure system, a development system, etc., which are not shown, a transfer section 47 composed of a transfer roller, etc., (not shown) and a fixing section 49 composed of a fixing roller, etc., (not shown). The engine section 41 prints out an image on a sheet of paper by using image data which has been read by the scanner section 21, image data which has been transmitted from a client personal computer (PC) etc., by a local area network (LAN) via the network I/F section 63, and image data of facsimile data etc., which has been received from an external facsimile machine etc., by the facsimile communication section 65. More specifically, the paper conveying section 43 conveys a sheet of paper to the image forming section 45, which forms a toner image corresponding to the foregoing image data. The transfer section 47 transfers the toner image to the sheet of paper. The fixing section 49 fixes the toner image on the sheet of paper to form an image.

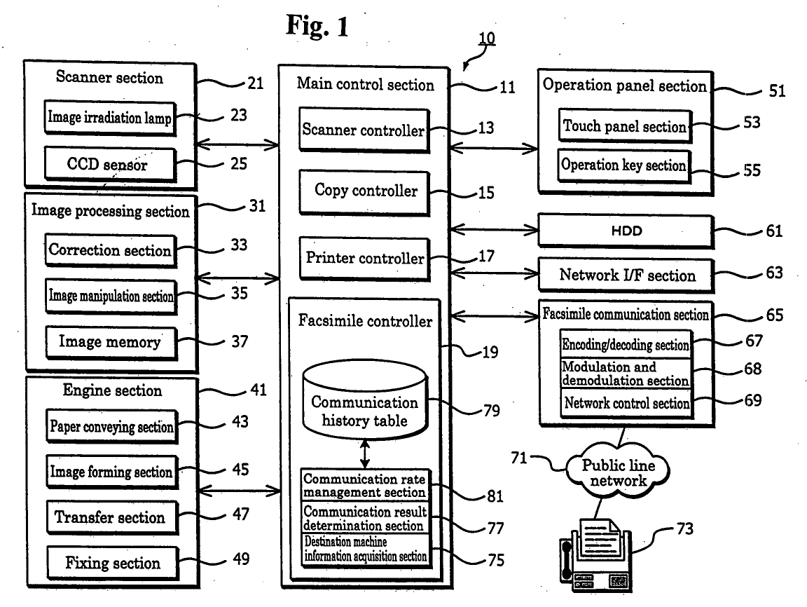

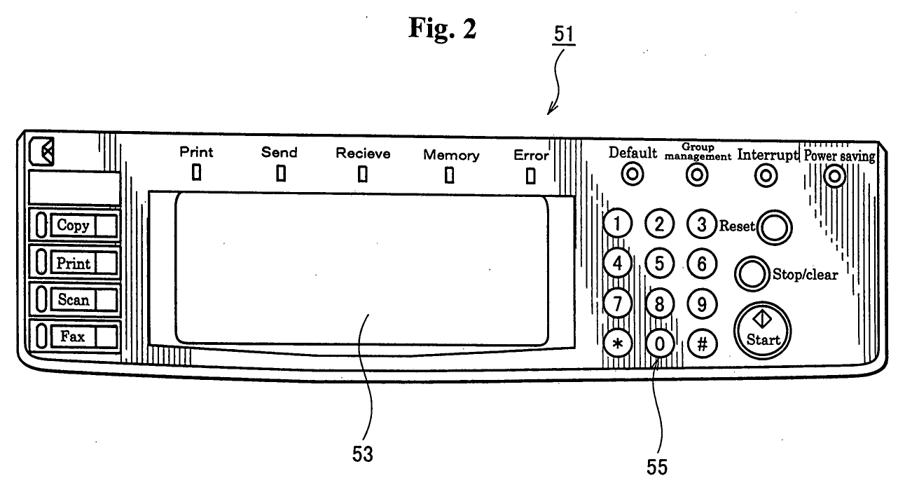

The operation panel section 51 includes a touch panel section 53 and an operation key section 55 as shown in FIG. 1 and FIG. 2. The operation panel section 51 is used in order that a user may conduct an operation related to a facsimile function, a scanner function, a printer function, or a copy function etc. The operation panel section 51 provides the main control section 11 with an operation command, etc., by the user.

The touch panel section (corresponding to a ‘display section’ of the present invention) 53 is composed of a touch panel unit combined with a touch panel and a color liquid crystal display (LCD). The touch panel section 53 displays various operation screens, for example, information on a document size, a copy size, and the number of copies in executing the copy function, and also displays an operation button and the like in order that the user may input various operation commands by touching a relevant place.

The operation key section 55 includes a plurality of operation keys to accept an operation input by the user. The operation key section 55 is used, for example, when the user selectively executes a key input operation for a necessary function from among various functions such as the facsimile function, the copy function, the printer function, and the scanner function. More specifically, for example, the operation key section 55 is used when the user conducts a ten-key input operation to select a destination machine in using the facsimile function or when the user conducts an input operation of a one touch dial or a speed dial.

The hard disk drive (HDD) 61 stores image data which has been read by the scanner section 21 and various data such as the output format being set in the image data. The image data stored in the HDD 61 is not only used inside the facsimile machine, a program, and a recording medium but also checked from a client PC, etc., via the network I/F section 63 or transferred to a predetermined folder on a client PC, a file transfer protocol (FTP) server, etc., as necessary.

The network I/F section 63 controls transmission and reception of various data relative to a user terminal 67 such as a client PC, etc., connected via the LAN, with use of a network interface (10/100 Base-TX).

The facsimile communication section 65 has a function of transmitting image data of a document which has been read by the scanner section 21 to a destination machine 73 via a public line network (corresponding to a ‘communication medium’ of the present invention) 71 and receiving image data which has been transmitted by the destination machine 73. The facsimile communication section 65 is constructed so as to include an encoding/decoding section 67, a modulation and demodulation section 68, and a network control section 69.

The encoding/decoding section 67 has a function of compressing and encoding image data of a document targeted for transmission and decompressing and decoding received image data.

The modulation and demodulation section 68 has a function of modulating compressed/encoded image data to an audio signal and demodulating a received audio signal to image data.

The network control section 69 corresponds to a network control unit (NCU) and has a function of performing network control of delivering a dial signal to the public line network 71, etc.

On the other hand, in order to suppress the frequency of occurrence of communication errors as much as possible and also achieve high communication efficiency even when the public line network 71 is in a poor condition, the facsimile controller 19 housed in the main control section 11 is constructed so as to include a destination machine information acquisition section 75 acquiring destination machine information including facsimile number thereof, a communication result determination section 77 determining whether a communication error occurs during image data communication with a destination machine, a communication history table 79 combining a function that when a determination that a communication error occurs is made by the communication result determination section 77, a communication rate at the time of occurrence of the communication error is stored as associated with a relevant destination machine, with a function that each time image data communication with a destination machine is conducted a communication history including a communication date and time, the presence of a communication error, and a communication rate is stored as associated with a relevant destination machine, and a communication rate management section 81 combining a function of reading out a communication rate at the time of occurrence of a communication error with a destination machine having been selected by a user, based on the stored information in the communication history table 79 when starting image data communication with the destination machine, calculating a communication rate with the destination machine 73 in consideration of having a decrease by at least one level or more from the read-out communication rate, and having the facsimile communication section 65 execute communication processing with the destination machine 73 at the calculated communication rate, with a function of reading out a communication history of the destination machine based on the stored information in the communication history table 79 and updating the stored information related to the communication rate at the time of occurrence of the communication error in the communication history table 79 based on the read-out communication history.

### [Operation of the Facsimile Machine According to the Embodiment of the Present Invention]

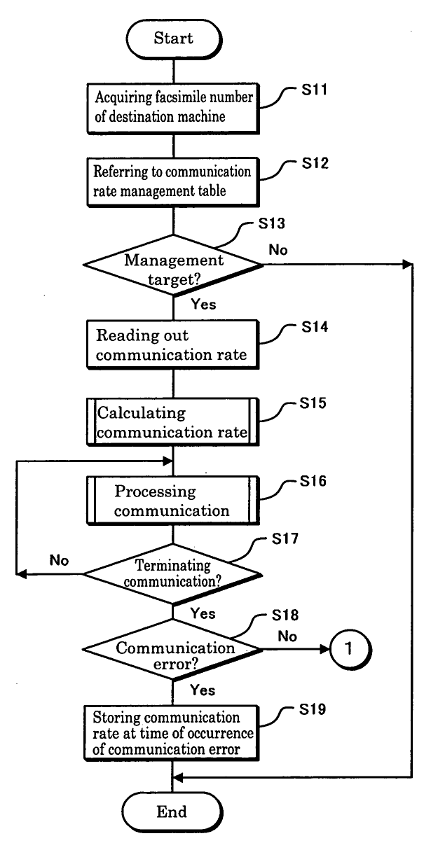

Next, an operational flow of the facsimile machine according to the embodiment of the present invention will be described with reference to FIGS. 3 to 5.

As shown in FIG. 3, the destination machine information acquisition section 75 acquires destination machine information on a facsimile number of a destination machine 73 in facsimile communication (Step S11). Subsequently, the communication rate management section 81 checks whether the facsimile number of the destination machine 73 is registered in management target data (facsimile numbers of destinations) in the communication history table 79, based on the destination machine information having been acquired in Step S11 and the stored information in the communication history table 79 (Steps S12 and S13).

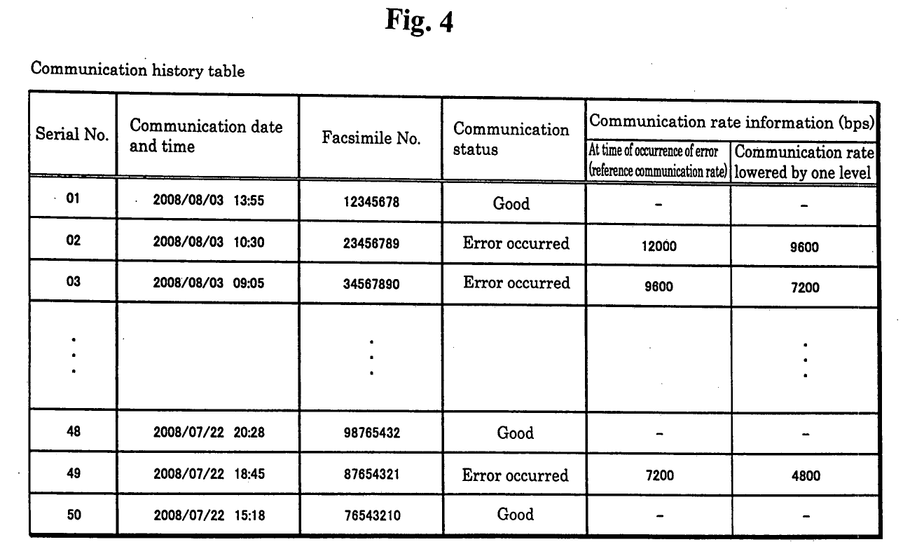

When a determination that the facsimile number of the destination machine 73 is registered in the management target data in the communication history table 79 is made, as a result of the determination in Step S13, the communication rate management section 81 reads out a communication rate at the time of occurrence of a communication error having been registered as associated with the relevant destination machine 73 from the communication history table 79 (Step S14). Subsequently, the communication rate management section 81 calculates a communication rate with the destination machine 73 in consideration of having a decrease by at least one level or more from the read-out communication rate in Step S14 (Step S15). More specifically, the communication rate management section 81 sets the lowest rate selectively from among three rates; a communication rate of the destination machine 73 based on a non-standard function identification signal (NSF)/digital identification signal (DIS) having been received from the destination machine 73, a communication rate of the facsimile machine 10, and a communication rate lowered by one level from a read-out communication rate at the time of occurrence of a communication error in past communication with the destination machine 73 from the communication history table 79. Now, the communication rate calculation in Step S15 is described as exemplifying a case where the communication rate of the destination machine 73 is 14400 bps, the communication rate of the facsimile machine 10 is 14400 bps, and the destination machine 73 corresponds to serial number ‘02’ in the communication history table 79 shown in FIG. 4. The maximum communication rate of both of the facsimile machine 10 and the destination machine 73 is 14400 bps. The communication rate corresponding to the serial number ‘02’ is 12000 bps. The communication rate lowered by one level from this communication rate is 9600 bps. Thus, the lowest rate of 9600 bps among the three rates is selectively set as a communication rate between the facsimile machine 10 and the destination machine 73. By this means, a relatively low communication rate that is assumed to be able to obviate occurrence of communication errors is to be set as a communication rate between the facsimile machine 10 and the destination machine 73.

Subsequently, the communication rate management section 81 delivers a command signal of having the facsimile communication section 65 execute communication processing with the destination machine 73 at the communication rate having been calculated in Step S15. In response to that, the facsimile communication section 65 executes the communication processing with the destination machine 73 at the communication rate having been calculated in Step S15 (Step S16).

On the other hand, the facsimile controller 19 monitors whether the facsimile machine 10 transmits a disconnect (DCN) signal (disconnect command signal) to the destination machine 73, or a DCN signal is transmitted from the destination machine 73 to the facsimile machine 10 during the facsimile communication. Upon detecting the transmission or reception of the DCN signal, as a result of the monitoring, the facsimile controller 19 terminates the communication processing (Step S17).

Subsequently, the communication result determination section 77 determines whether a communication error occurs during the facsimile communication (Step S18).

When a determination that a communication error occurs is made, as a result of the determination in Step S18, the communication rate management section 81 stores a communication rate at the time of occurrence of the communication error in the communication history table 79 as associated with the relevant destination machine (Step S19). If a facsimile number of the relevant destination machine is unknown, the storing processing in Step S19 is not carried out.

The facsimile controller 19 terminates the flow of a series of processing, when any of the following cases apply; a determination that the facsimile number of the destination machine 73 is not registered in the management target data in the communication history table 79 is made as a result of the determination in Step S13, or the registration processing into the communication history table 79 in Step S19 is completed.

On the other hand, when a determination that a communication error does not occur is made as a result of the determination in Step S18, the communication rate management section 81 executes processing of updating or deleting the stored information in the communication history table 79 based on the communication history between the facsimile machine 10 and the destination machine 73.

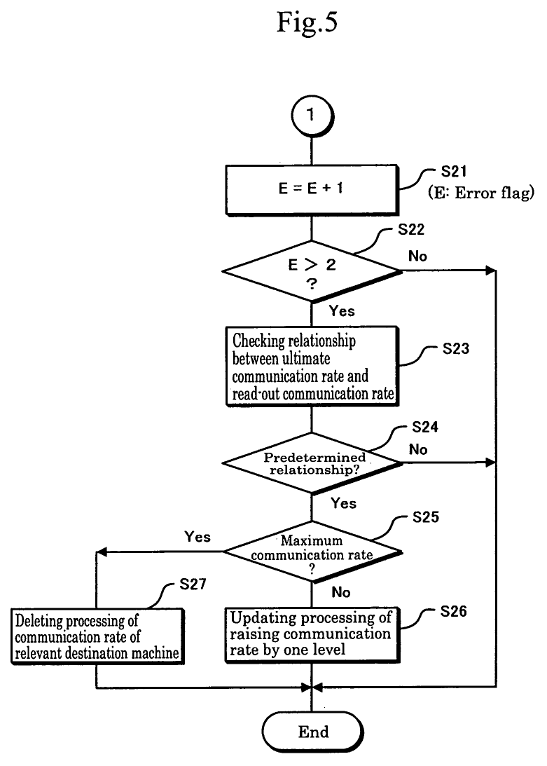

More specifically, as shown in FIG. 5, the communication rate management section 81 increments a count value ‘E’ of an error flag related to the destination machine 73 by ‘1’ (Step S21). The count value ‘E’ of the error flag related to the destination machine 73 is such that the communication rate at the time of occurrence of the communication error in communication with the destination machine 73 is read out from the communication history table 79, the communication processing is executed at a communication rate lowered by one level from the read-out communication rate of reference (herein after, sometimes referred to as a ‘reference communication rate’) as described in Steps S15 to S17, and an accumulated value of the number of times the communication processing succeeds in succession is stored for each different destination machine 73. Thus, the count value ‘E’ of the error flag related to the destination machine 73 is initialized to ‘0’ when the communication processing fails (in the case of ‘yes’ in Step S18).

The communication rate management section 81 determines whether the count value ‘E’ of the error flag related to the destination machine 73 exceeds a predetermined value ‘2’ although the predetermined value can be changed appropriately according to user requests (Step S22). In Step S22, a determination on whether the accumulated value of the number of times the communication processing succeeds in succession reaches 3 when executing the communication processing at a communication rate lowered by one level from the read-out reference communication rate from the communication history table 79, that is, whether the communication only at a communication rate lowered by one level from the reference communication rate succeeds at a predetermined number of times (3 times in the embodiment although including once) in succession is made.

When a determination that the communication at the communication rate lowered by one level from the reference communication rate succeeds three times in succession is made, as a result of the determination in Step S22, the communication rate management section 81 refers to a communication history of the relevant destination machine 73 based on the communication history table 79, thereby checking the relationship between an ultimate communication rate of the current successful communication and the read-out reference communication rate from the communication history table 79 (Step S23). Subsequently, the communication rate management section 81 makes a determination on whether the ultimate communication rate of the current successful communication is matched with the communication rate lowered by one level from the reference communication rate (Step S24).

When a determination that the ultimate communication rate of the current successful communication is matched with the communication rate lowered by one level from the reference communication rate is made, as a result of the determination in Step S24, the communication rate management section 81 makes a determination on whether the reference communication rate is matched with the maximum communication rate of the destination machine 73 (Step S25).

When a determination that the reference communication rate is not matched with the maximum communication rate of the destination machine 73 is made, as a result of the determination in Step S25, the communication rate management section 81 executes processing of updating the reference communication rate of the destination machine 73 to a communication rate raised by one level from the ultimate communication rate of the current successful communication (Step S26). Now, the communication rate updating processing in Step S26 is described as exemplifying a case where the ultimate communication rate between the facsimile machine 10 and the destination machine 73 is 9600 bps and the destination machine 73 corresponds to serial number ‘02’ in the communication history table 79 shown in FIG. 4. The reference communication rate of the destination machine 73 (the communication rate corresponding to the serial number ‘02’) is 12000 bps. The communication rate lowered by one level from this communication rate is matched with the ultimate communication rate of 9600 bps between the facsimile machine 10 and the destination machine 73. Thus, the communication rate updating processing of raising the reference communication rate of the destination machine 73 by one level from 12000 bps to 14400 bps is executed.

On the other hand, when a determination that the reference communication rate is matched with the maximum communication rate of the destination machine 73 is made, as a result of the determination in Step S25, the communication rate management section 81 executes processing of deleting a record of the destination machine 73 including the reference communication rate from the communication history table 79 (Step S27). A reason for deleting the record of the destination machine 73 including the reference communication rate from the communication history table 79 in Step S27 is that the condition of the public line network 71 is conceived to be improved to such an extent that the communication rate control is not necessary any longer. Now, the communication rate deleting processing in Step S26 is described as exemplifying a case where the ultimate communication rate between the facsimile machine 10 and the destination machine 73 is 12000 bps, the maximum communication rate of the destination machine 73 is 14400 bps, and the destination machine 73 corresponds to serial number ‘01’ in the communication history table 79 shown in FIG. 4. The reference communication rate of the destination machine 73 (the communication rate corresponding to the serial number ‘01’) is 14400 bps and is matched with the maximum communication rate of the destination machine 73. Therefore, the processing of deleting the record of the destination machine 73 including the reference communication rate (the record related to the serial number ‘01’) from the communication history table 79 is executed.

Now, a meaning of appropriate timing of updating management of the stored information in the communication history table in Steps S26 and S27 is described. On the assumption, in the facsimile machine according to the embodiment of the present invention, the communication rate between the facsimile machine and the destination machine is set based on the stored information in the communication history table 79. When the stored information once registered in the communication history table is maintained as it is without appropriately updating management of the information, the communication rate having been set to a lower rate side comes to be maintained as it is even if the condition of the communication medium is improved afterward, whereupon a problem arises in terms of improvements in communication efficiency. Thus, the appropriate timing of updating management of the stored information in the communication history table 79 becomes necessary.

The communication rate management section 81 terminates the flow of a series of processing when any of the following cases apply; a determination that the communication at the communication rate lowered by one level from the reference communication rate does not succeed three times in succession is made as a result of the determination in Step S22, a determination that the ultimate communication rate of the current successful communication is not matched with the communication rate lowered by one level from the reference communication rate is made as a result of the determination in Step S24, or the communication rate updating processing in Step S26 or the communication rate deleting processing in Step S27 is completed.

### [Facsimile Communication Procedure in the Facsimile Machine According to the Embodiment of the Present Invention]

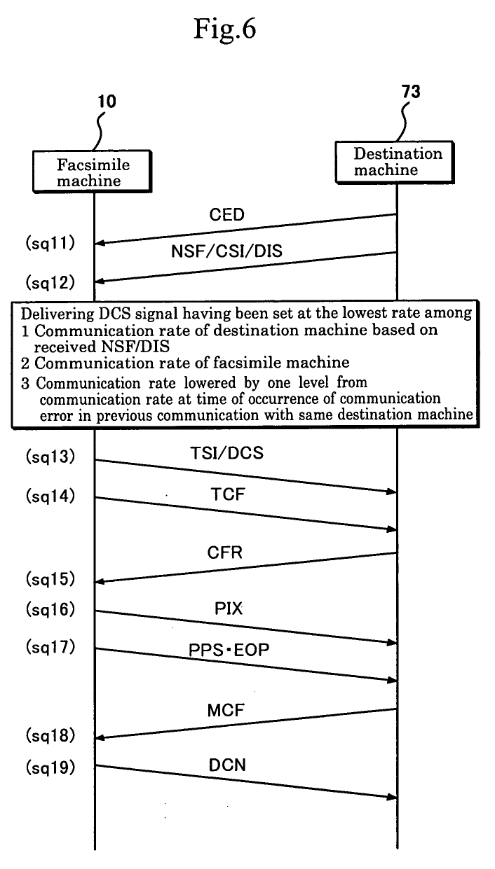

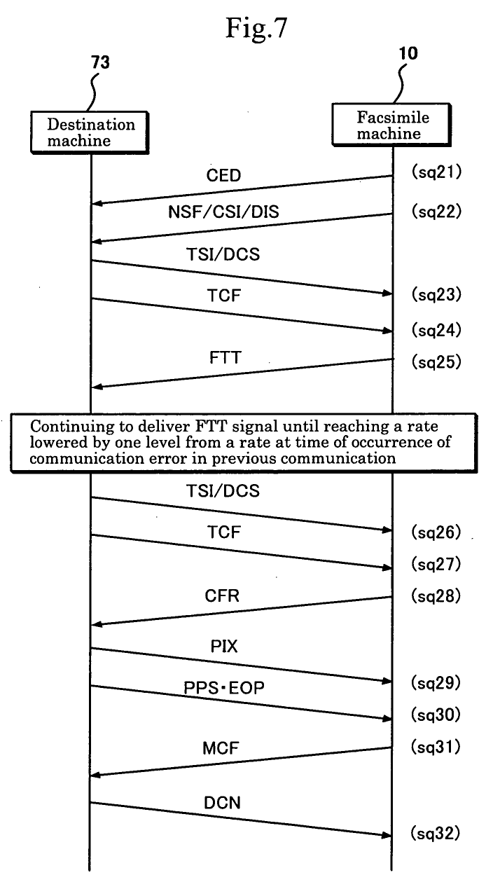

Subsequently, a facsimile communication procedure between the facsimile machine 10 and the destination machine 73 will be described with reference to FIGS. 6 to 8. Numbers in parentheses in FIG. 6 and FIG. 7 indicate sequence numbers.

### (Procedure in Transmitting Image Data by Facsimile)

When image data of a document is transmitted by facsimile from the facsimile machine 10 to the destination machine 73, as shown in FIG. 6, a calling tone (CNG) is first delivered from the facsimile machine 10 to the destination machine 73. In response to that, the destination machine 73 delivers a called station identification signal (CED) (sequence number (herein after, abbreviated as ‘sq’) 11) and also delivers a non-standard function identification signal (NSF), a called station identification signal (CSI), and a digital identification signal (DIS) (sq12).

Upon receiving those signals, the facsimile machine 10 delivers a transmitting station identification signal (TSI) and a digital command signal (DCS) (sq13). In the digital command signal (DCS) in sequence number: sq13, the lowest rate is set selectively from among a communication rate of the destination machine 73 based on the received non-standard function identification signal (NSF)/digital identification signal (DIS), a communication rate of the facsimile machine 10, and a communication rate lowered by one level from a read-out communication rate at the time of occurrence of a communication error in past communication with the destination machine 73 from the communication history table 79. By this means, a relatively low communication rate that is assumed to be able to obviate occurrence of communication errors is to be set as a communication rate between the facsimile machine 10 and the destination machine 73.

After that, the destination machine 73 receives a training check signal (TCF) from the facsimile machine 10 (sq14) and then returns a ready-to-receive confirmation signal (CFR) (sq15).

Upon receiving the ready-to-receive confirmation signal (CFR), the facsimile machine 10 delivers the document image data (PIX) at a communication rate having been notified in advance by the digital command signal (DCS) (sq16), and then delivers a partial page signal (PPS)/end-of-procedure signal (EOP) (sq17).

The destination machine 73 having received the end-of-procedure signal (EOP) returns a message confirmation signal (MCF) (sq18).

Upon receipt of the message confirmation signal (MCF), the facsimile machine 10 delivers a disconnect command signal (DCN) (sq19). Here, a series of facsimile transmission processing is terminated and the line is disconnected.

### (Procedure in Receiving Image Data by Facsimile)

When image data of a document having been transmitted from the destination machine 73 to the facsimile machine 10 is received by facsimile, as shown in FIG. 7, the facsimile machine 10 first receives a calling tone (CNG) having been transmitted from the destination machine 73 thereto. In response to that, the facsimile machine 10 delivers a called station identification signal (CED) (sq21) and also delivers a non-standard function identification signal (NSF), a called station identification signal (CSI), and a digital identification signal (DIS) (sq22).

Upon receiving those signals, the destination machine 73 delivers a transmitting station identification signal (TSI) and a digital command signal (DCS) (sq23), and then delivers a training check signal (TCF) (sq24).

Upon receipt of the training check signal (TCF) from the destination machine 73, the facsimile machine 10 continues to return a training failure signal (FTT) until a communication rate that is assumed to be appropriate between the facsimile machine 10 and the destination machine 73 is set (sq25). More specifically, in sequence number: sq25, the facsimile machine 10 reads out a communication rate at the time of occurrence of a communication error in communication with the destination machine 73 from the communication history table 79 and continues to deliver a training failure signal (FTT) until a communication rate lowered by one level from the read-out communication rate is attained. By this means, the communication rate shifted to a lower rate side for the purpose of obviating communication errors can be set as a rate used in communication processing between the facsimile machine 10 and the destination machine 73.

When the facsimile machine 10 receives the transmitting station identification signal (TSI) and the digital command signal (DCS) having been delivered from the destination machine 73 (sq26) and then receives the training check signal (TCF) (sq27), the facsimile machine 10 returns a ready-to-receive confirmation signal (CFR) since a desired communication rate setting is completed in sequence number: sq25 (sq28).

Upon receipt of the ready-to-receive confirmation signal (CFR), the destination machine 73 delivers the document image data (PIX) (sq29) and then delivers a partial page signal (PPS)/end-of-procedure signal (EOP) (sq30).

The facsimile machine 10 having received the end-of-procedure signal (EOP) returns a message confirmation signal (MCF) (sq31).

Upon receiving the message confirmation signal (MCF), the destination machine 73 delivers a disconnect command signal (DCN) (sq32). Now, a series of facsimile reception processing is terminated and the line is disconnected.

### Effects of the Embodiment

According to the facsimile machine 10 in accordance with the embodiment of the present invention, as described above, the communication rate management section 81 reads out a communication rate at the time of occurrence of a communication error related to a destination machine 73 having been selected by a user, based on the stored information in the communication history table 79, when starting image data communication with the destination machine 73. At the same time, the communication rate management section 81 calculates a communication rate with the destination machine 73 in consideration of having a decrease by at least one level or more from the read-out communication rate, and then has the facsimile communication section 65 execute communication processing with the destination machine 73 at the calculated communication rate. By this means, with reference to the communication rate at the time of occurrence of a communication error with the destination machine 73 in the past, the communication processing with the destination machine 73 is executed at the communication rate with a decrease by at least one level or more from the reference communication rate. That is, the communication processing with the destination machine 73 is executed at a relatively low communication rate that is assumed to be able to obviate occurrence of communication errors. As a result, the frequency of occurrence of communication errors can be suppressed as much as possible even when the public line network 71 (communication medium) is in a poor condition.

Further, according to the facsimile machine 10 in accordance with the embodiment of the present invention, the communication rate management section 81 reads out a communication history related to the destination machine 73 based on the stored information in the communication history table 79, and updates the stored information in the communication history table 79 based on the read-out communication history. Thus, the communication rate of the destination machine 73 is updated appropriately based on the communication history. As a result, not only can the frequency of occurrence of communication errors be suppressed as much as possible but also high communication efficiency can be achieved even when the public line network 71 (communication medium) is in a poor condition.

In a conventional facsimile machine having an error correction mode (ECM) communication function for correcting errors automatically during communication, no error occurs at the training check (TCF) stage when communication is executed in the non-ECM communication mode for not correcting errors automatically during communication. However, there is a possibility that an error line appears in an image when an error occurs during transmission of image data. On the other hand, the communication processing is executed at a relatively low communication rate that is assumed to be able to obviate occurrence of communication errors in the facsimile machine 10 according to the embodiment of the present invention. Therefore, avoidance of appearance of error lines as much as possible can be expected. That is, according to the facsimile machine 10 in accordance with the embodiment of the present invention, actualization of particularly superior communication error suppression effect can be expected in the public line network 71 (communication medium) that tends to lapse into a poor condition unexpectedly.

Further, although no error occurs at the training check (TCF) stage when communication is executed in the ECM communication mode for correcting errors automatically during communication in the conventional facsimile machine, re-transmission of image data needs to be repeated four times until the communication rate of the image data is reduced if pursuant to a general communications protocol, when an error occurs during transmission of the image data. On the other hand, the facsimile machine 10 according to the embodiment of the present invention allows for variable settings so as to reduce the communication rate of image data in the early stages, so that realization of high communication efficiency can be expected.

### [Others]

The present invention should not be restricted to the aforementioned embodiment and can be modified appropriately without departing from the gist or technical idea of the present invention understood entirely from the claims and the specification. Facsimile machines with such modifications are also to fall within the technical scope of the present invention.

More specifically, an example of registering a communication rate at the time of occurrence of a communication error in past communication with the destination machine 73 into the communication history table 79 as associated with the destination machine 73 is described in the embodiment of the present invention. However, the present invention is not restricted to the example. More specifically, such a mode can be adopted that even when a communication error occurs in past communication with the destination machine 73, its communication rate is not registered depending on details of the communication error. As the details of the communication error in this case, a mode that the communication error is not related to the public line network 71 (communication medium) can be exemplified. More specifically, for example, a communication error when receiving a rejection from a destination machine provided with security locking by password as a result of trial communication to the destination machine in spite of having no communication authority, and a communication error arising from a full memory state of the destination machine, etc., can be included. In such cases, the communication error is unavoidable even if the communication rate is reduced. Therefore, by disallowing the communication rate at the time of occurrence of the communication error to be stored in the communication history table 79, an exception from the communication rate registration target at the time of occurrence of communication errors becomes possible.

Further, en example of reading out a communication rate at the time of occurrence of a communication error in past communication with a destination machine 73 from the communication history table 79 and then selectively setting a communication rate lowered by one level from the read-out communication rate as a communication rate between the facsimile machine 10 and the destination machine 73 is described in the embodiment of the present invention. However, the present invention is not restricted to this example. More specifically, a communication rate lowered by necessary levels such as two levels or three levels from the read-out communication rate from the communication history table 79 may be selectively set. Description of a setting example in this case is given. Such a configuration can be adopted that the communication rate management section 81 has a function of calculating an error rate of image data at the time of occurrence of a communication error, calculates a communication rate with the relevant destination machine based on the error rate of image data having been obtained by the calculation and the read-out communication rate, and has the facsimile communication section 65 execute communication processing with the destination machine at the calculated communication rate. More specifically, the following configuration may be adopted; in calculating the error rate of image data at the time of occurrence of a communication error, the communication rate management section 81 calculates an occurrence rate of error lines relative to normal lines in the case of non-ECM communication, where as the communication rate management section 81 calculates an occurrence rate of error frames relative to the total number of transmitted and received ECM frames in the case of ECM communication. When a determination that the error rate is high is made based on a result of the calculation, with reference to the read-out communication rate from the communication history table 79, a communication rate lowered by necessary levels such as two levels or three levels from the reference communication rate is selectively set depending on the degree of the error rate.

Further, an example where the communication rate management section 81 updates the stored information in the communication history table 79 such that a communication rate with the destination machine has an increase by one level when communication processing with the destination machine at the communication rate calculated according to predetermined rules succeeds over a predetermined number of times in succession is described in the embodiment of the present invention. However, the present invention is not restricted to this example. More specifically, the stored information in the communication history table 79 may be updated such that the communication rate with the destination machine has an increase by predetermined levels such as two levels or three levels.

Moreover, whether the communication at the communication rate lowered by one level from the reference communication rate succeeds at a predetermined number of times (three times in the embodiment) in succession is exemplarily described as a determination factor in updating the communication rate between the facsimile machine 10 and the destination machine 73 in the embodiment of the present invention. However, the present invention is not restricted to the example. That is, for example, a mode of adopting the error rate of image data at the time of occurrence of a communication error as the determination factor in updating the communication rate between the facsimile machine 10 and the destination machine 73, and changing the aforementioned predetermined number of times dynamically may be adopted. Description of a setting example in this case is given. The communication rate management section 81 has a function of calculating an error rate of image data at the time of occurrence of a communication error, and for example, has the communication rate updating processing executed at the point when one time of communication is normally terminated if the error occurrence rate of image data having been obtained by the calculation is 0%, has the communication rate updating processing carried out at the point when only a predetermined number of times (three times, for example) of communication is normally terminated if the error occurrence rate is 1 to 25%, or disallows the communication rate updating processing to be carried out no matter how many times of communication is normally terminated if the error occurrence rate is 26% or more. Like this, the mode for changing the aforementioned predetermined number of times dynamically can be adopted. As for a method for calculating the error occurrence rate, the aforementioned example may be adopted.

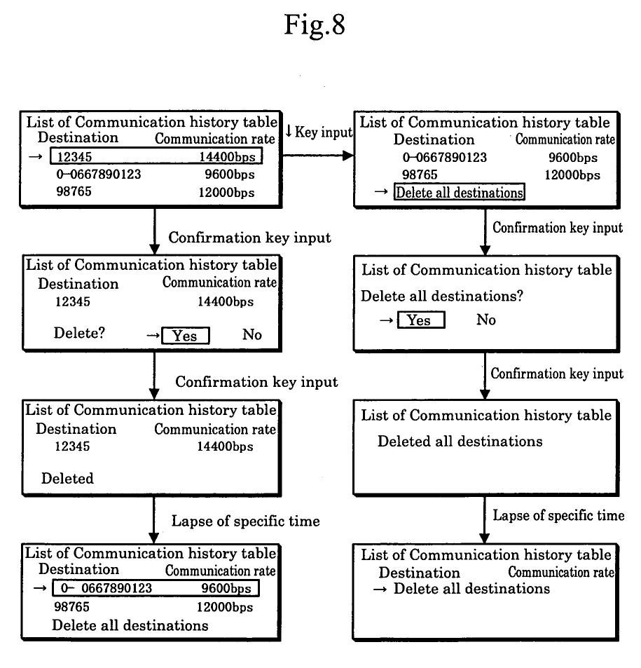

As a function the communication rate management section 81 actualizes, there may be adopted a function of having an operation of combining one or two or more of the following carried out according to user operation instructions; printing out, list-displaying to the touch panel section 53, taking out as external output data, updating, and deleting the stored information in the communication history table 79. More specifically, as shown in FIG. 8, for example, a function of printing out a list of ‘destination machine facsimile numbers’ and ‘reference communication rates’ stored in the communication history table 79 as a report or displaying the list on the touch panel section 53 is added. Further, a function of changing a ‘reference communication rate’ of any destination or deleting a record of any destination from the communication history table 79 by user's key input operation with use of the operation key section 55 is added. If thus configured, the stored information in the communication history table 79 can be changed and set appropriately as necessary by user operation. Even when an installed-facsimile environment is changed (for example, when a communication common carrier is changed, moving from one house to another house, etc.), ‘reference communication rates’ stored in the communication history table 79 are placed under user control, thereupon allowing various problems derived from communication rates to be cleared.

What is claimed is:

1. A facsimile machine comprising:
a facsimile communication section executing image data communication processing via a communication medium between the facsimile machine and a destination machine at a communication rate selected according to predetermined rules among a plurality of communication rates set in a stepwise manner;
a communication result determination section determining whether a communication error occurs during image data communication with a destination machine;
a communication history table in which when a determination that a communication error occurs is made in the communication result determination section, a communication rate at the time of occurrence of the communication error is stored as associated with a relevant destination machine; and
a communication rate management section reading out a communication rate at the time of occurrence of a communication error related to a destination machine having been selected by a user, based on stored information in the communication history table, when starting image data communication with the destination machine, the communication rate management section also calculating a communication rate with the destination machine in consideration of having a decrease by at least one level or more from the read-out communication rate, and having the facsimile communication section execute the communication processing with the destination machine at the calculated communication rate.

2. The facsimile machine according to claim 1, wherein the communication result determination section further has a function of determining whether the communication error is related to the communication medium, and when a determination that a communication error occurs is made in the communication result determination section and a determination that the communication error is not related to the communication medium is made, a communication rate at the time of occurrence of the communication error is stored in the communication history table as associated with a relevant destination machine whereas when a determination that a communication error occurs is made in the communication result determination section and a determination that the communication error is related to the communication medium is made, a communication rate at the time of occurrence of the communication error is not stored in the communication history table.

3. The facsimile machine according to claim 1, wherein the communication rate management section further has a function of calculating an error rate of image data at the time of occurrence of the communication error, calculates a communication rate with the destination machine based on the error rate of image data having been obtained by the calculation and the read-out communication rate, and has the facsimile communication section execute communication processing with the destination machine at the calculated communication rate.

4. The facsimile machine according to claim 1, wherein each time image data communication with a destination machine is carried out a communication history including a presence of occurrence of a communication error and a communication rate is stored in the communication history table as associated with a relevant destination machine, and the communication rate management section reads out the communication history of the destination machine based on the stored information in the communication history table and updates the stored information related to the communication rate at the time of occurrence of the communication error in the communication history table based on the read-out communication history.

5. The facsimile machine according to claim 4, wherein the communication rate management section updates the stored information in the communication history table such that the communication rate with the destination machine has an increase by at least one level or more when the communication processing with the destination machine at the calculated communication rate succeeds over a predetermined number of times in succession.

6. The facsimile machine according to claim 5, wherein the communication rate management section deletes the stored information related to the communication rate at the time of occurrence of the communication error related to the destination machine from the communication history table when the updated stored information in the communication history table is matched with a maximum communication rate of the destination machine.

7. The facsimile machine according to claim 4, wherein the communication rate management section further has a function of calculating an error rate of image data at the time of occurrence of the communication error, refers to the error rate of image data having been obtained by the calculation, and updates the stored information related to the communication rate at the time of occurrence of the communication error in the communication history table such that the communication rate with the destination machine has an increase by at least one level or more.

8. The facsimile machine according to claim 4, wherein the communication rate management section has an operation of combining one or two or more of the following carried out according to user operation instructions; printing out, displaying to a display section, taking out as external output data, updating, and deleting the stored information in the communication history table.
